(19) United States
(12) Patent Application Publication
(10) Pub. No.: US 2026/0205905 A1
(43) Pub. Date: Jul. 16, 2026

(54) SYSTEMS AND METHODS FOR DIVERSITY MULTIPLE TRANSMISSION RECEPTION POINT HANDOVER

(71) Applicant: Verizon Patent and Licensing Inc., Basking Ridge, NJ (US)

(72) Inventors: Lap Tse, Marietta, GA (US); Samirkumar Patel, Middlesex, NJ (US); Francisco X. Sevilla R., Eden Prairie, MN (US); Jeremy J. Winkelman, Scottsdale, AZ (US); David Taft, Keller, TX (US)

(21) Appl. No.: 19/022,066

(22) Filed: Jan. 15, 2025

(51) Int. Cl. H04W 36/00; H04W 72/1263

(52) U.S. Cl. CPC H04W 36/00838; H04W 72/1263

(57) ABSTRACT

Systems and methods described herein provide an advanced multiple Transmission Reception Point (mTRP) handover service. A network device, such as a RAN intelligent controller (RIC), may receive an indication that a handover procedure is required for a UE device and select between a first handover procedure that uses one transmission and reception point (TRP) for the UE device and a second handover procedure that uses multiple TRPs for the UE device. The network device may notify a source cell and a target cell of the second handover procedure when the second handover procedure is selected.

### BACKGROUND

Cellular networks (e.g., Fifth Generation (5G) networks) provide various services and applications to user devices connected via a radio access network (RAN). For example, Next Generation (NG) wireless networks, such as 5G New Radio (5G NR) networks are being deployed and are under development. End devices may connect to a RAN according to various types of configurations and may be afforded different quality of service (QoS) levels.

Multiple Transmission Reception Point (mTRP) architecture is a technology enhancement in 5G NR networks that enables multiple transmission and reception points to communicate with end devices. For example, mTRP enables 5G gNodeB (gNB) base stations to simultaneously use more than one transmission and reception point (TRP) to communicate with an end device.

### BRIEF DESCRIPTION OF THE DRAWINGS

FIG. 1 is a diagram that depicts an example network environment in which an embodiment of an advanced mTRP handover service may be implemented;

FIGS. 2A-2C are diagrams illustrating concepts described herein for handover of an uplink data transfer;

FIGS. 3A-3C are diagrams illustrating concepts described herein for handover of a downlink data transfer;

FIG. 4 is a diagram illustrating communications in another example network environment in which an embodiment of the advanced mTRP handover service may be implemented;

FIGS. 5A and 5B are signal flow diagrams illustrating example communications to conduct a handover using the advanced mTRP handover service;

FIG. 6 is a diagram illustrating example components of a device that may correspond to one or more of the devices illustrated and described herein; and

FIG. 7 is a flow diagram illustrating an exemplary process for conducting a handover using the advanced mTRP handover service, according to an implementation.

### DETAILED DESCRIPTION

The following detailed description refers to the accompanying drawings. The same reference numbers in different drawings may identify the same or similar elements. Also, the following detailed description does not limit the invention.

In a mobility context, cellular service providers need to support continuity and availability of data connections to provide a good user experience for customers while maximizing the benefits of 5G connections. However, switching between different frequency bands, core networks, and/or RANs can cause service interruptions when an end device changes network connections mid-session. Currently, there is a data interruption gap during cell-to-cell handover. The data interruption gap is generally a 30 to 150 millisecond (mS) duration where there is no data flow between connected 5G user equipment (UE) and the 5G RAN.

The actual duration of the data interruption can depend on the type of cell-to-cell handover. For example, the data interruption during a handover may vary depending on whether the same or different baseband unit (BBU)/distributed unit (DU)/gNB are involved, whether the handover is among the same Radio Access Technology (RAT) or inter-RAT, or whether fallback mechanisms (e.g., a release with redirection) are used. In some use cases, the data interruption may not adversely affect the user experience. However, the data interruption may be disruptive for certain low latency or real time video use cases. For example, a low latency cloud gaming session at 60 frames per second (fps) may notice a data interruption at approximately 16.7 mS, and a 30 fps real time dashcam video may notice a data interruption at approximately 33 mS.

UE devices may be offered with different transmit (Tx) and receive (Rx) capabilities. Many UE devices, such as conventional smart phones, are limited to 1-channel Tx and 2-channel Rx capability due to size, power, and cooling limits. Some UE devices, however, have mTRP capability that may be employed to effectively eliminate the data interruption during handovers, according to implementations described herein. For example, 5G routers typically have 2-channel Tx and 4-channel Rx capability to connect to a 5G RAN and provide internet connectivity to other devices, such as computers, smartphones, dashcams, and smart home devices. Other types of UE devices may also have 2-channel Tx and 4-channel Rx capability. As used herein, devices with capabilities to support mTRP may be referred to as "advanced UEs."

Systems and methods described herein provide an advanced multiple Transmission Reception Point (mTRP) handover service. In one embodiment, a network device, such as a RAN intelligent controller (RIC), may receive an indication that a handover procedure is required for a UE device and select between a standard handover procedure that uses one transmission and reception point (TRP) for the UE device and an advanced handover procedure that uses multiple TRPs for the UE device. The network device may notify a source cell (e.g., a gNB) and a target cell (e.g., a different gNB) of the advanced handover procedure, when the advanced handover procedure is selected.

In another embodiment, handover instructions may be provided to the UE device, to perform a handover to the target cell for a first transmit channel and to maintain a user plane connection with the source cell for a second transmit channel. In still another embodiment, handover instructions may be provided to the UE device, to perform a handover to the target cell for the second transmit channel after completion of a handover to the target cell for a first transmit channel. In another embodiment, the handover instructions to the target cell for the first transmit channel include instructions for 2-to-1 multiplexing over the first transmit channel and the second transmit channel.

In view of the foregoing, the advanced mTRP handover service may improve, reduce, or eliminate data interruptions during handovers. The advanced mTRP handover service may also improve continuity of data connections, particularly for low latency applications.

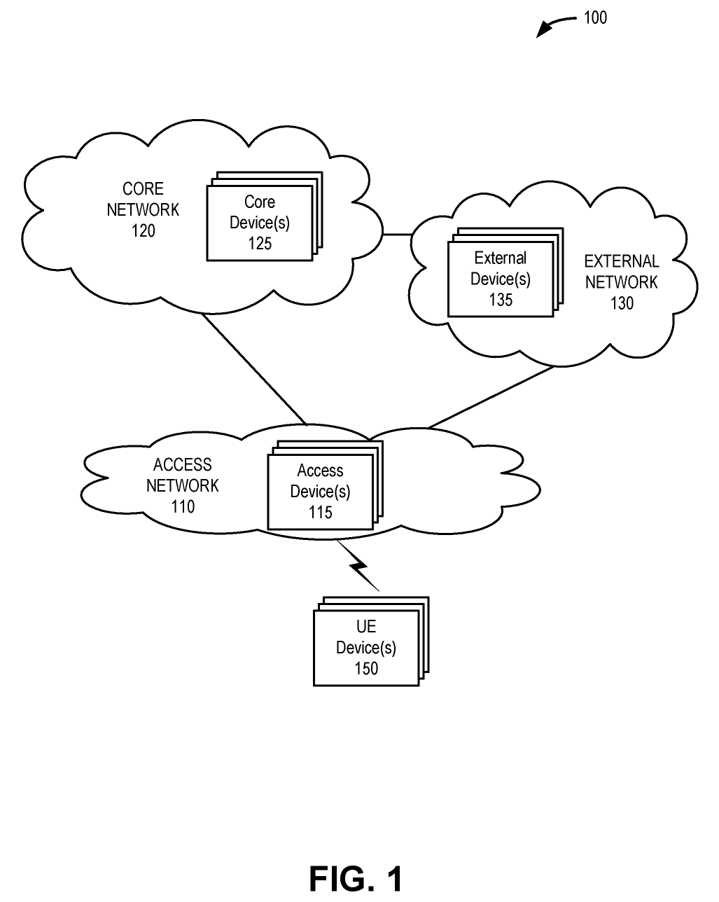

FIG. 1 is a diagram illustrating an example environment 100 in which an embodiment of an advanced mTRP handover service may be implemented. As illustrated, environment 100 includes an access network 110, a core network 120, and an external network 130. Access network 110 includes access devices 115 (also referred to individually or generally as access device 115). Core network 120 includes core devices 125 (also referred to individually or generally as core device 125). External network 130 includes external devices 135 (also referred to individually or generally as external device 135). Environment 100 further includes UE devices 150 (also referred to individually or generally as UE device 150).

The number, type, and arrangement of networks illustrated in environment 100 are exemplary. For example, according to other embodiments, environment 100 may include fewer networks, additional networks, and/or different networks. For example, according to other implementations, other networks not illustrated in FIG. 1 may be included, such as an X-haul network (e.g., backhaul, mid-haul, fronthaul, etc.), a transport network (e.g., Signaling System No. 7 (SS7), etc.), or another type of network that may support a wireless service and/or an application service, as described herein.

A network device, a network element, or a network function (referred to herein simply as a network device) may be implemented according to one or multiple network architectures, such as a client device, a server device, a peer device, a proxy device, a cloud device, and/or a virtualized network device. Additionally, a network device may be implemented according to various computing architectures, such as centralized, distributed, cloud (e.g., elastic, public, private, etc.), edge, fog, and/or another type of computing architecture, and may be incorporated into distinct types of network architectures (e.g., Software Defined Networking (SDN), client/server, peer-to-peer, etc.) and/or implemented with various networking approaches (e.g., logical, virtualization, network slicing, etc.). The number, the type, and the arrangement of network devices are exemplary.

Environment 100 includes communication links between the networks and between the network devices. Environment 100 may be implemented to include wired, optical, and/or wireless communication links. A connection via a communication link may be direct or indirect. For example, an indirect connection may involve an intermediary device and/or an intermediary network not illustrated in FIG. 1. A direct connection may not involve an intermediary device and/or an intermediary network. The number, type, and arrangement of communication links illustrated in environment 100 are exemplary.

Environment 100 may include various planes of communication including, for example, a control plane, a user plane, a service plane, and/or a network management plane. Environment 100 may include other types of planes of communication. A message communicated in support of the advanced mTRP handover service may use at least one of these planes of communication.

Access network 110 may include one or multiple networks of one or multiple types and technologies. For example, access network 110 may be implemented to include a 5G RAN, a future generation RAN (e.g., a Sixth Generation (6G) RAN, a Seventh Generation (7G) RAN, or a subsequent generation RAN), a centralized-RAN (C-RAN), an Open-RAN (O-RAN), and/or another type of access network. Access network 110 may include a legacy RAN (e.g., a Third Generation (3G) RAN, a Fourth Generation (4G) RAN, or 4.5G RAN, etc.). Access network 110 may communicate with and/or include other types of access networks, such as, for example, a WI-FI network, a Worldwide Interoperability for Microwave Access (WiMAX) network, a local area network (LAN), a Citizens Broadband Radio System (CBRS) network, a cloud RAN, a virtualized RAN (vRAN), a self-organizing network (SON), a wired network (e.g., optical, cable, etc.), or another type of network that provides access to or can be used as an on-ramp to access network 110.

Access network 110 may include different and multiple functional splitting, such as options 1, 2, 3, 4, 5, 6, 7, or 8 that relate to combinations of access network 110 and core network 120 including an Evolved Packet Core (EPC) network and/or an NG core (NGC) network, or the splitting of the various layers (e.g., physical layer, media access control (MAC) layer, radio link control (RLC) layer, and packet data convergence protocol (PDCP) layer, etc.), plane splitting (e.g., user plane, control plane, etc.), interface splitting (e.g., F1-U, F1-C, E1, Xn-C, Xn-U, X2-C, Common Public Radio Interface (CPRI), etc.) as well as other types of network services, such as dual connectivity (DC) or higher (e.g., a secondary cell group (SCG) split bearer service, a master cell group (MCG) split bearer, an SCG bearer service, non-standalone (NSA), standalone (SA), etc.), carrier aggregation (CA) (e.g., intra-band, inter-band, contiguous, non-contiguous, etc.), edge and core network slicing, coordinated multipoint (CoMP), various duplex schemes (e.g., frequency division duplex (FDD), time division duplex (TDD), half-duplex FDD (H-FDD), etc.), and/or another type of connectivity service (e.g., NSA new radio (NR), SA NR, etc.).

According to some embodiments, access network 110 may be implemented to include various architectures of wireless service, such as, for example, macrocell, microcell, femtocell, picocell, metrocell, NR cell, Long Term Evolution (LTE) cell, non-cell, or another type of wireless architecture. Additionally, according to various embodiments, access network 110 may be implemented according to various wireless technologies (e.g., RATs, etc.), and various wireless standards, frequencies, bands, and segments of radio spectrum (e.g., centimeter (cm) wave, millimeter (mm) wave, below 6 gigahertz (GHz), above 6 GHz, higher than mm wave, C-band, licensed radio spectrum, unlicensed radio spectrum, above mm wave), and/or other attributes or technologies used for radio communication. Additionally, or alternatively, according to some embodiments, access network 110 may be implemented to include various wired and/or optical architectures for wired and/or optical access services.

Depending on the implementation, access network 110 may include one or multiple types of network devices, such as access devices 115. For example, access device 115 may include a gNB, an eLTE eNodeB (eNB), an eNB, a radio network controller (RNC), a RAN intelligent controller (RIC), a base station controller (BSC), a remote radio head (RRH), BBU, a radio unit (RU), a remote radio unit (RRU), a centralized unit (CU), a CU-control plane (CP), a CU-user plane (UP), a DU, a small cell node (e.g., a picocell device, a femtocell device, a microcell device, a home eNB, a home gNB, etc.), an open network device (e.g., O-RAN Centralized Unit (O-CU), O-RAN Distributed Unit (O-DU), O-RAN next generation Node B (O-gNB), O-RAN evolved Node B (O-eNB)), a 5G ultra-wide band (UWB) node, a future generation wireless access device (e.g., a 6G wireless station, a 7G wireless station, or another generation of wireless station), or another type of wireless node (e.g., a WI-FI device, a WiMax device, a hotspot device, a fixed wireless access CPE (FWA CPE), etc.) that provides a wireless access service. Additionally, access devices 115 may include a wired and/or an optical device (e.g., modem, wired access point, optical access point, Ethernet device, multiplexer, etc.) that provides network access and/or transport service.

According to some implementations, access device 115 may include a combined functionality of multiple radio access technologies (RATs) (e.g., 4G and 5G functionality,5G and 5.5G functionality, etc.) via soft and hard bonding based on demands and needs. According to some implementations, access device 115 may include a split access device (e.g., a CU-control plane (CP), a CU-user plane (UP), etc.) or an integrated functionality, such as a CU-CP and a CU-UP, or other integrations of split RAN nodes. Access device 115 may be an indoor device or an outdoor device.

According to an exemplary embodiment, at least some of access devices 115 may include logic of an embodiment of the advanced mTRP handover service. For example, a RIC, an RNC, a BSC, or similar type of network device that may manage, control, and/or configure cellular access stations of access network 110 (referred to herein simply as a RIC device) may provide a decision to use the advanced mTRP handover service (i.e., with parallel data paths, also referred to as "make-before-break") or a standard handover (i.e., with a single path, also referred to as "break-before-make"). According to an exemplary embodiment, the RIC device may receive an indication that a handover procedure is required for a UE device and select between a standard handover procedure that uses one mTRP access point and an advanced handover procedure that uses two mTRP access points.

On the uplink, the RIC device may instruct that UE device 150 uses two transmit channels for the advance handover. This will allow for a continuous data transfer between the UE device and RAN on the uplink, since one Tx branch will be able to send data to a source cell (e.g., a gNB) while the other Tx branch performs the handover with the target cell (e.g., another gNB). On the downlink, the RIC device may instruct that UE device 150 apply half of the total radio receiver channels towards the source cell and simultaneously apply the other half of the radio receiver channels towards a target cell. This will allow for a continuous data transfer between the UE device and RAN on the downlink, since half of the total Rx branches will be able to receive data while the other half of the Rx branches performs the handover.

The RIC device may base a selection decision on advertised mTRP capabilities of the UE device, indications of actual dual Tx/Rx connections, and/or a stored profile of the UE device. In other implementations, the RIC device may also base a selection decision on network conditions and/or performance parameters. By way of further example, the performance parameters may relate to latency, throughput, reliability, packet error rate, bit rate, jitter, and/or similar types of information, such as key performance indicators (KPIs), Quality of Service (QoS) Identifiers (e.g., a 5G QoS Identifier (5QI) or a QoS Class Identifier (QCI), service level agreements (SLAs), and the like. When the advanced handover procedure is selected, the RIC device may notify the source cell (e.g., a gNB) and the target cell of the advanced handover procedure.

According to an exemplary embodiment, at least some other access devices 115 may include logic of an embodiment of the advanced mTRP handover service. For example, a gNB or another type of cellular wireless station of access network 110 (referred to herein as a cellular access station) may provide the advanced mTRP handover service. The cellular access station may decide when a handover is required, request (e.g., from a RIC device) a handover type decision, communicate to a UE device a selected handover type (e.g., advance or standard), and establish communications with a target cellular access station for data path diversity.

Core network 120 may include one or multiple networks of one or multiple network types and technologies. Core network 120 may include a complementary network of access network 105. For example, core network 120 may be implemented to include a 5G core network, an evolved packet core (EPC) of an LTE network, an LTE-Advanced (LTE-A) network, and/or an LTE-A Pro network, a future generation core network (e.g., a 5.5G, a 6G, a 7G, or another generation of core network), and/or another type of core network.

Depending on the implementation, core network 120 may include diverse types of core devices 125. Core devices 125 may include, for example, a user plane function (UPF), a Non-3GPP Interworking Function (N3IWF), an access and mobility management function (AMF), a session management function (SMF), a unified data management (UDM) device, a unified data repository (UDR), an authentication server function (AUSF), a security anchor function (SEAF), a network slice selection function (NSSF), a network repository function (NRF), a policy control function (PCF), a network data analytics function (NWDAF), a network exposure function (NEF), a mobility management entity (MME), a packet data network gateway (PGW), and/or a serving gateway (SGW).

According to other exemplary implementations, core devices 125 may include additional, different, and/or fewer network devices than those described. For example, core devices 125 may include a non-standard or a proprietary network device, and/or another type of network device that may be well-known but not described herein. Core devices 125 may also include a network device that provides a multi-RAT functionality (e.g., 4G and 5G, 5G and 5.5G, 5G and 6G, etc.), such as an SMF with PGW control plane functionality (e.g., SMF+PGW-C), a UPF with PGW user plane functionality (e.g., UPF+PGW-U), and/or other combined nodes. Also, core devices 125 may include a split core device 125. For example, core devices 125 may include a session management (SM) PCF, an access management (AM) PCF, a user equipment (UE) PCF, and/or another type of split architecture associated with another core device 125.

External network 130 may include one or multiple networks of one or multiple types and technologies that provide an application service. For example, external network 130 may be implemented using one or multiple technologies including, for example, network function virtualization (NFV), software defined networking (SDN), cloud computing, Infrastructure-as-a-Service (IaaS), Platform-as-a-Service (PaaS), Software-as-a-Service (SaaS), or another type of network technology. External network 130 may be implemented to include a cloud network, a private network, a public network, a Multi-access Edge Computing (MEC) network, a fog network, the Internet, a packet data network (PDN), a service provider network, the World Wide Web (WWW), an Internet Protocol Multimedia Subsystem (IMS) network, a Rich Communication Service (RCS) network, a software-defined (SD) network, a virtual network, a packet-switched network, a data center, a data network, or other type of application service layer network that may provide access to and may host an end device application service.

Depending on the implementation, external network 130 may include various network devices, such as external devices 135. For example, external devices 135 may include virtual network devices (e.g., virtualized network functions (VNFs), servers, host devices, application functions (AFs), application servers (ASs), server capability servers (SCSs), containers, hypervisors, virtual machines (VMs), pods, network function virtualization infrastructure (NFVI), and/or other types of virtualization elements, layers, hardware resources, operating systems, engines, etc.) that may be associated with application services for use by UE devices 150. By way of further example, external devices 135 may include mass storage devices, data center devices, NFV devices, SDN devices, cloud computing devices, platforms, and other types of network devices pertaining to various network-related functions (e.g., security, management, charging, billing, authentication, authorization, policy enforcement, development, etc.).

External network 130 may include one or multiple types of external devices 135. External devices 135 may host one or multiple types of application services. For example, the application services may pertain to broadband services in dense areas (e.g., pervasive video, smart office, operator cloud services, video/photo sharing, etc.), broadband access everywhere (e.g., 50/100 Mbps, ultra-low-cost network, etc.), enhanced mobile broadband (eMBB), higher user mobility (e.g., high speed train, remote computing, moving hot spots, etc.), Internet of Things (e.g., smart wearables, sensors, mobile video surveillance, smart cities, connected home, etc.), extreme real-time communications (e.g., tactile Internet, augmented reality (AR), virtual reality (VR), etc.), lifeline communications (e.g., natural disaster, emergency response, etc.), ultra-reliable communications (e.g., automated traffic control and driving, collaborative robots, health-related services (e.g., monitoring, remote surgery, etc.), drone delivery, public safety, etc.), broadcast-like services, communication services (e.g., email, text (e.g., Short Messaging Service (SMS), Multimedia Messaging Service (MMS), etc.), massive machine-type communications (mMTC), voice, video calling, video conferencing, instant messaging), video streaming, fitness services, navigation services, and/or other types of wireless and/or wired application services. External devices 135 may also include other types of network devices that support the operation of external network 130 and the provisioning of application services, such as an orchestrator, an edge manager, an operations support system (OSS), a local domain name system (DNS), registries, and/or external devices 135 that may pertain to various network-related functions (e.g., security, management, charging, billing, authentication, authorization, policy enforcement, development, etc.). External devices 135 may include non-virtual, logical, and/or physical network devices.

UE device 150 may include a device that has communication capabilities (e.g., wireless, wired, optical, etc.). UE device 150 may or may not have computational capabilities. UE device 150 may be implemented as a mobile device, a portable device, a stationary device (e.g., a non-mobile device and/or a non-portable device), a device operated by a user, or a device not operated by a user. In one implementation, UE device 150 may be an advanced UE device with capabilities to use the advanced mTRP handover service. Advanced UE devices typically have larger power sources, cooling capacity, and volumes than typical hand-held end devices and can support mTRP, such as 2-channel Tx and 4-channel Rx capability. For example, an advanced UE device may include a Tx/Rx unit with at least two transmitters for transmitting data via multiple antennas and at least four receivers for receiving data via multiple antennas. In other implementation, the advanced UE device 150 may include separate Tx units and Rx units for different bands. Examples of an advanced UE device 150 may include a 5G router, a vehicle telematics device, a mobile wireless access device, or another wireless device that includes 2-channel Tx and 4-channel Rx capability.

In other implementations, a smartphone, a mobile phone, a personal digital assistant, a tablet, a netbook, a wearable device (e.g., a watch, glasses, headgear, a band, etc.), a computer, a gaming device, a television, a set top box, a music device, an IoT device, a drone, a smart device, a fixed wireless device, a router, a sensor, an automated guided vehicle (AGV), an industrial robot, or other type of wireless device (e.g., another type of end device) may be equipped as an advance UE device 150. The number and the types of software may vary among UE devices 150. For purposes of description only, UE device 150 is not considered a network device. UE device 150 may be implemented as a virtualized device in whole or in part.

In one implementation, UE device 150 may include logic to support the advanced mTRP handover service. For example, UE device 150 may generate a measurement report and transmit the measurement report to a source cellular access station (also referred to a source cell). UE device 150 may receive from the source cellular access station a handover command, which may include radio resource control (RRC) connection reconfiguration information and a target cellular access station (also referred to a target cell). UE device 150 may perform RRC reconfiguration procedures in accordance with instructions to support the advanced mTRP handover service and may provide duplicate multiplexed Data Radio Bearer (DRB) streams on separate Tx paths during a handover procedure.

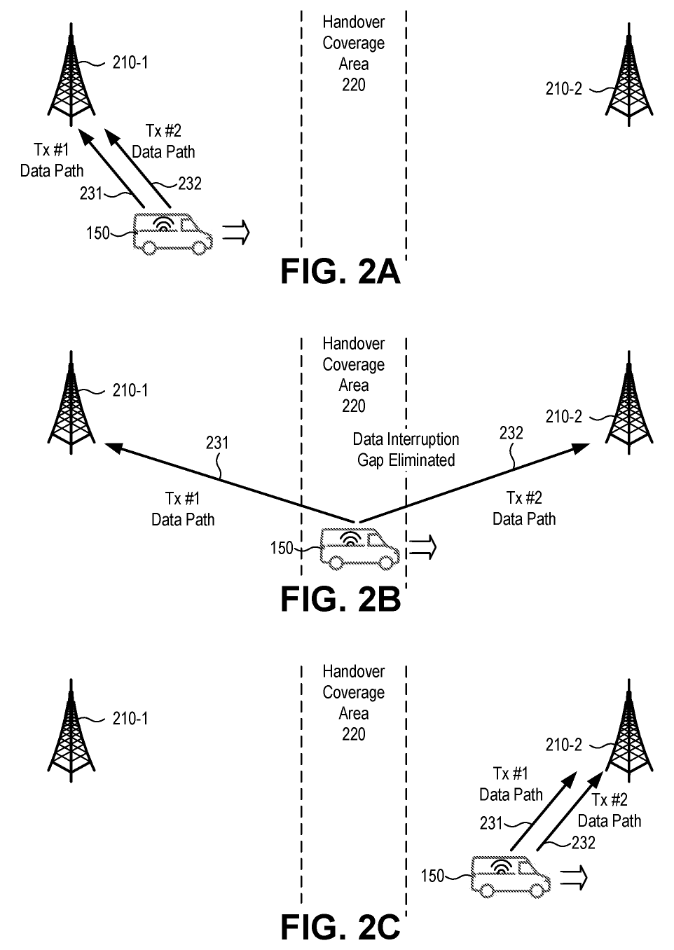

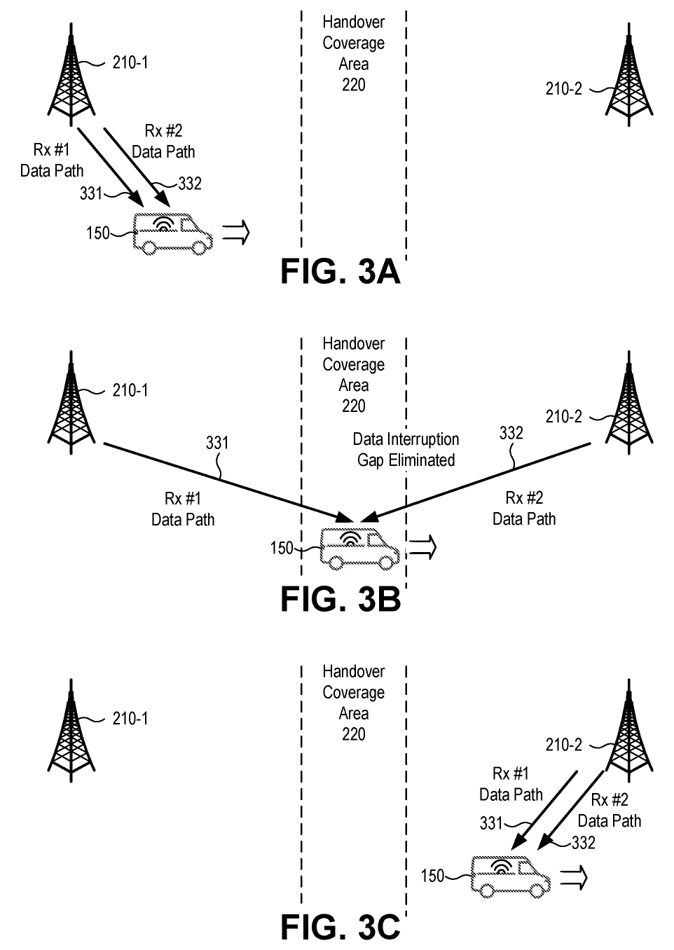

FIGS. 2A-3C illustrates concepts described herein. More particularly, FIGS. 2A-2C illustrate a handover for an uplink data transfer using the advanced mTRP handover service, and FIGS. 3A-3C illustrate a handover for a downlink data transfer using the advanced mTRP handover service. As shown in FIGS. 2A-3C, an advanced UE 150 may be in transit between coverage areas (or cells) of a source cellular access station 210-1 (e.g., a gNB) and a target cellular access station 210-2 (e.g., another gNB) for a RAN. Cellular access stations 210-1 and 210-2 may be referred to collectively as cellular access stations 210. A handover coverage area 220 is indicated where a cell-to-cell handover is typically initiated, based on signal strength. Typically, without the advanced mTRP handover service, a data interruption occurs while advanced UE 150 is in handover coverage area 220 and a UE device changes uplink and/or downlink transmissions from cellular access station 210-1 to cellular access station 210-2 (or vice versa).

As shown in FIG. 2A, prior to entering handover coverage area 220, advanced UE 150 may use two data paths to conduct uplink communication with cellular access station 210-1. For example, advanced UE 150 may use both a first data path 231 (e.g., Tx #1 data path) and a second data path 232 (e.g., Tx #1 data path) to provide high-bandwidth, low-latency communications. Upon entering handover coverage area 220, as shown in FIG. 2B, advanced UE 150 may use one radio transmission branch (e.g., data path 231) towards cellular access station 210-1 and simultaneously use the second radio transmission branch (e.g., data path 232) towards cellular access station 210-2. Use of different data paths directed to the different cellular access station 210-1/210-2 allows for a continuous data transfer between advanced UE 150 and the RAN on the uplink, since one of the two Tx branches (e.g., data path 231) will be able to transmit un-interrupted data while the other branch (e.g., data path 232) performs the handover. As shown in FIG. 2C, once the handover is complete, advanced UE 150 may use two data paths to conduct uplink communication with cellular access station 210-2.

As shown in FIG. 3A, prior to entering handover coverage area 220, advanced UE 150 may use two or more data paths to receive downlink communication from cellular access station 210-1. For example, advanced UE 150 may use up to four available data receiving paths, including a first data path 331 (e.g., Rx #1 data path) and a second data path 332 (e.g., Rx #1 data path) to receive high-bandwidth, low-latency communications. Upon entering handover coverage area 220, as shown in FIG. 3B, advanced UE 150 may use up to half of the radio receiving branches (e.g., data path 331) from cellular access station 210-1 and simultaneously use the second half of the radio receiving branches (e.g., data path 332) from cellular access station 210-2. Use of different data paths from the different cellular access stations 210-1/210-2 allows for a continuous data reception between advanced UE 150 and the RAN on the downlink, since half of the two Rx branches (e.g., data path 331) will be able to transmit un-interrupted data while the other half (e.g., data path 332) performs the handover. As shown in FIG. 3C, once the handover is complete, advanced UE 150 may use the two or more data paths to receive downlink communication from cellular access station 210-2.

As described further herein, new functionality for data aggregation and data package management (duplicate, multiplexing, discards, re-ordering) is provided at one or more of a PDCP layer, a CU/UPF layer, and a RIC layer to support the advanced mTRP handover service. According to one implementation, handover thresholds for triggers, activation, and hysteresis of the advanced mTRP handover service may be optimized on a per cell basis and per frequency band basis.

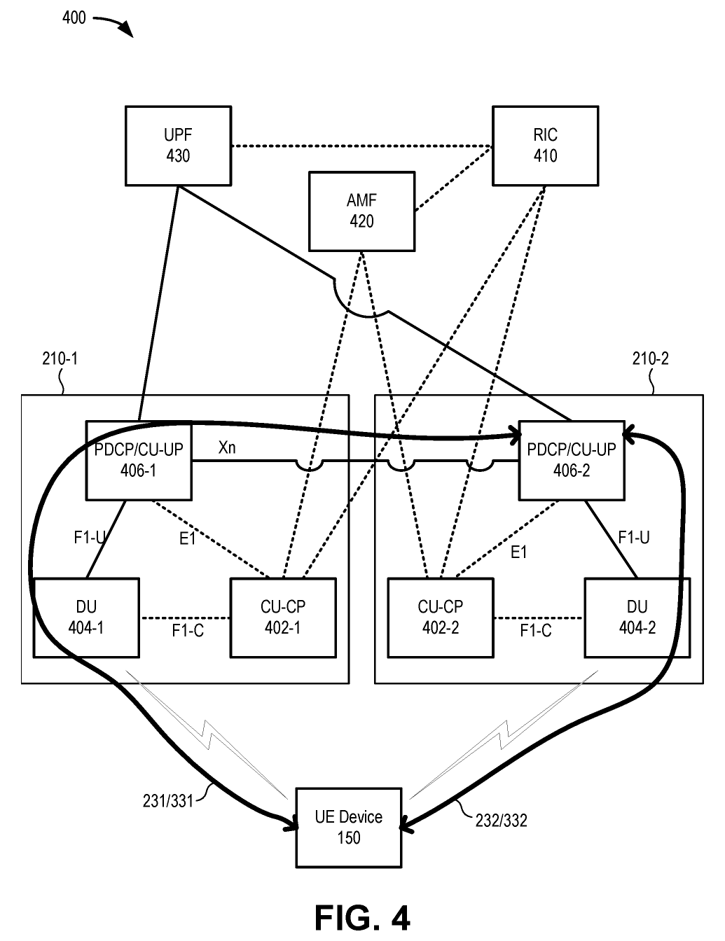

FIG. 4 is a diagram illustrating communications for the advanced mTRP handover service in a portion 400 of network environment 100. More particularly, FIG. 4 illustrates communications for the advanced mTRP handover service within a handover coverage area that might otherwise result in a data interruption gap. Network portion 400 may include UE device 150, cellular access stations 210-1 and 210-2, a RIC device 410, AMF 420, and UPF 430. Each of RIC device 410, AMF 420, and UPF 430 may be implemented, for example, on core devices 125.

RIC device 410 may provide intelligent radio resource management, QoS management, connectivity management, and handover management in a RAN. For example, RIC device 410 may control and optimize various radio resources, such as the selection of access devices (e.g., gNB, CU, eNB), etc.) associated with a 4G, 5G, or future RAN. In some implementations, RIC device 410 may include a non-real-time and a near-real-time component. For example, RIC device 410 may support real-time intelligent radio resource management. RIC device 410 may control and optimize various radio resources of radio access devices (e.g., RU, DU, gNB, RRH, eNB, etc.) associated with a 4G, 5G, or future RAN, radio resource scheduling for uplink and downlink communication with UE device 150, and radio signal characteristics (e.g., modulation, beam management, etc.). RIC device 410 may also support non-real-time intelligent radio resource management, higher layer procedure optimization, and policy optimization in a RAN.

According to an embodiment, RIC device 410 may include logic of the advanced mTRP handover service, as described herein. RIC 410 may identify, for example, cell-specific thresholds and/or criteria to determine if a particular UE device 150 is eligible for an advanced handover. In one implementation, handover triggers, activation, and hysteresis thresholds may be optimized for each handover coverage area 220 and/or frequency band. In another implementation, a type of handover selected for a particular UE device 150 may be based on policies (e.g., service area restrictions, RAT frequency selection priority (RFSP) index, 5QI a service level, and/or a network slice type) and/or resource limitations (e.g., network congestion). Thus, in some instances, an advanced UE device 150 may not be granted an advance handover for policy reasons.

According to another implementation, RIC 410 may include a machine learning (ML) component based on feedback to optimize handover thresholds (e.g., handovers for first and second data paths) at each cell using the advanced mTRP handover service. For example, ML algorithms may account for different geographies, obstacles, signal interference, distances, etc., for different handover coverage areas 220. According to an embodiment, the ML component may include logic that creates, trains, re-trains, tunes, and/or updates a model (e.g., an artificial intelligence model, an ML model, a learning-based model, a custom model, a prediction model, etc.) using visited cell history information (e.g., historical, current, prospective, etc.), other network information, an ML algorithm, an AI algorithm, a deep learning algorithm, or another type of learning algorithm, as described herein. According to various implementations, the learning algorithm may include a supervised learning algorithm, an unsupervised learning algorithm, and/or a reinforcement learning algorithm. The ML component may include logic that includes predictive analytics. For example, the ML component may include a model that may be implemented as a Support Vector Machine, a Decision Tree, a Neural Network, Naïve Bayes, Random Forest, another type of learning-based algorithm, and/or a non-learning-based algorithm/rule-based logic. In still other implementations, the ML component may account for capabilities of different UE device 150 types, such as capabilities of different types of 5G routers, that may affect handover parameters. In one aspect, the model training function for RIC 410 may reside in a non-real time RIC portion and an inference model function may reside in a near-real-time RIC, a CU-CP 402 or a PDCP layer.

AMF 420 may perform registration management, connection management, reachability management, mobility management, lawful intercepts, Short Message Service (SMS) transport, session management message transport between UE device 150 and a Session Management Function (SMF), access authentication and authorization, location services management, functionality to support non-3GPP access networks, and/or other types of management processes. According to implementations described herein, AMF 420 may include logic of the advanced mTRP handover service, as described herein. For example, AMF 420 may coordinate advanced handovers between a source cellular access station 210-1 and a target cellular access station 210-2.

UPF 430 may maintain an anchor point for intra/inter-RAT mobility, maintain an external protocol data unit (PDU) point of interconnect to a particular data network (e.g., external network 130), perform packet routing and forwarding, perform the user plane part of policy rule enforcement, perform packet inspection, perform lawful intercept, perform traffic usage reporting, perform QoS handling in the user plane, perform uplink traffic verification, perform transport level packet marking, perform downlink packet buffering, forward an “end marker” to a RAN node (e.g., cellular access stations 210), and/or perform other types of user plane processes. According to implementations described herein, UPF 430 may include logic of the advanced mTRP handover service, as described herein.

Each of cellular access stations 210 may include, among other functions, a CU-CP 402, a DU 404, and a PDCP/CU-UP 406. CU-CP 402 includes a logical node that hosts RRC, and other control plane functions (e.g., Service Data Adaptation Protocol (SDAP) and/or PDCP for the PDCP/CU-UP 406 and for the DUs 404 and RUs that it controls. According to implementations described herein, CU-CP 402 may include logic of the advanced mTRP handover service, as described herein. For example, CU-CP 402 may provide handover instructions as selected by RIC device 410 and/or AMF 420.

Each DU 404 includes a logical node that hosts functions associated with the Radio Link Control (RLC) layer, the Medium Access Control (MAC) layer, and/or the physical layer (PHY). Each DU 404 further performs centralized processing and coordination of one or more RUs, which are located at certain geographic positions within access network 110 and transmit and receive radio frequency (RF) signals to/from UE devices 150.

PDCP/CU-UP 406 may interconnect with one or more DUs 404 via fronthaul links or a fronthaul network. PDCP/CU-UP 406, among other functions, routes outgoing traffic (e.g., from UE device 150, to a DU 404, and to CU-UP 402) to a UPF 430 and routes incoming traffic (from UPF 430) to a DU 404 that serves the traffic’s destination UE device 150. According to implementations described herein, PDCP/CU-UP 406 may include logic of the advanced mTRP handover service, as described herein. For example, PDCP/CU-UP 406 may demultiplex duplicate multiplexed DRB streams received via different cellular access stations 210.

As shown in FIG. 4, during a handover procedure, data from/to UE device 150 may traverse uplink path 231/downlink path 331 and uplink path 232/downlink path 332. For example, PDCP/CU-UP 406-1 may use an Xn interface to transfer uplink user plane data to PDCP/CU-UP 406-2. PDCP/CU-UP 406-2 and/or UPF 430 may perform aggregation, de-duplication, re-ordering of packets that can be forwarded toward a target recipient.

Although FIG. 4 shows certain components of network portion 400, in other implementations, network portion 400 may include fewer components, different components, differently arranged components, or additional components than depicted in FIG. 4. For example, although not illustrated in FIG. 4, network portion 400 may include other network functions (e.g., implemented in access devices 115, core devices 125, external devices 135, etc.), such as an SMF, a Unified Data Management (UDM), a Policy Control Function (PCF), a Network Exposure Function (NEF), etc. Additionally, or alternatively, one or more components of network portion 400 may perform functions described as being performed by one or more other components of network portion 400. Furthermore, while particular interfaces (e.g., Xn, E1, F1-C, F1-U, etc.) are illustrated with respect to particular functional nodes in FIG. 4, some network functions may include other interfaces, such as a reference point architecture that includes point-to-point interfaces between particular function nodes.

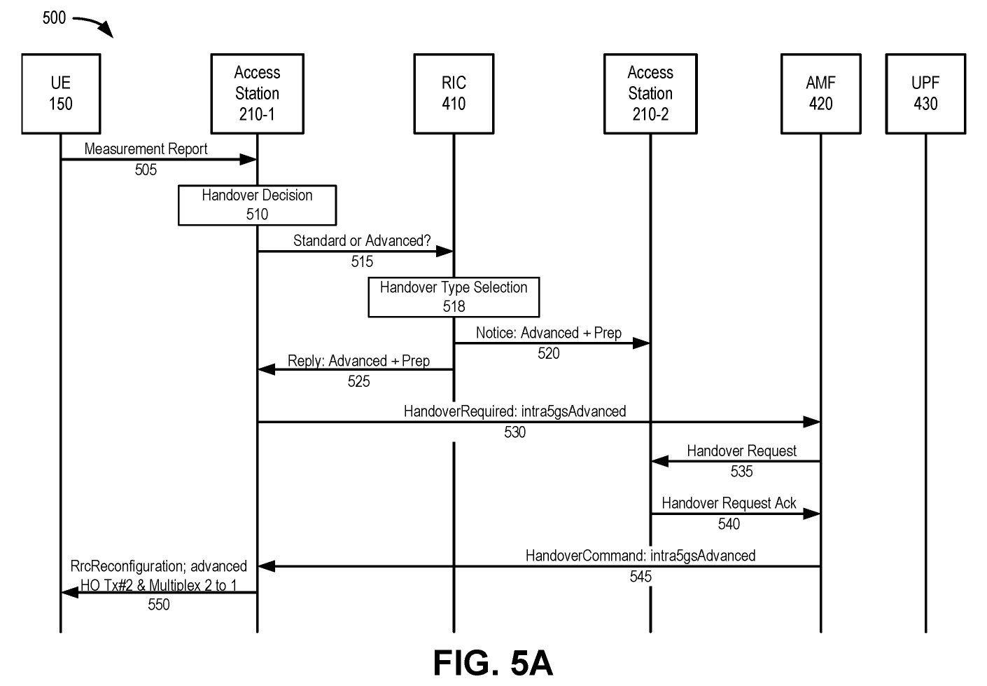

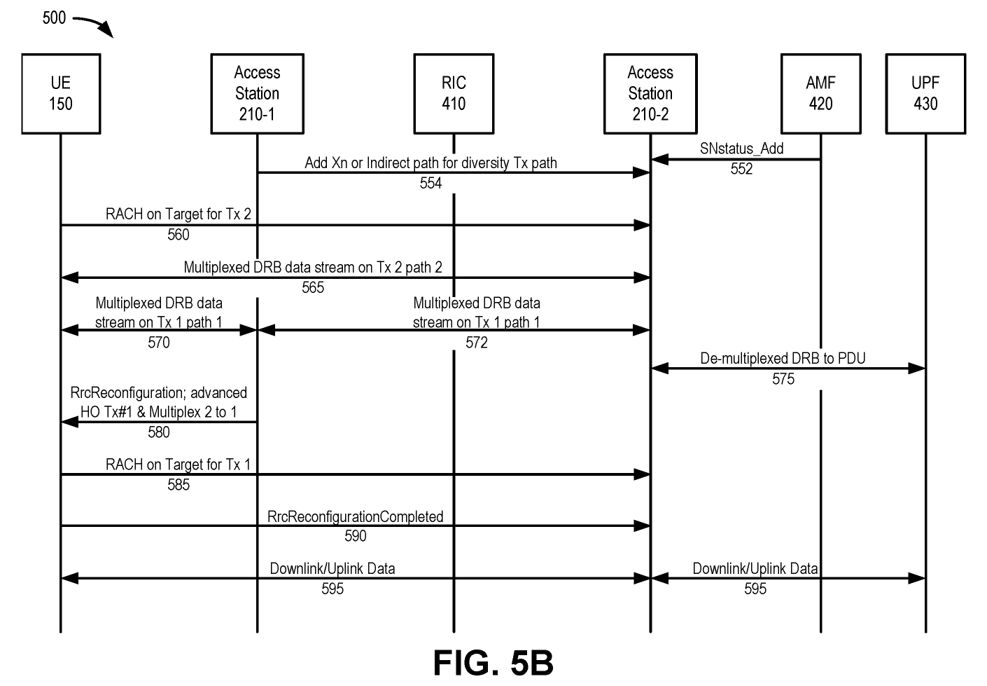

FIGS. 5A and 5B are signal flow diagrams illustrating communications for implementing the advanced mTRP handover service in a portion 500 of network environment 100. Network portion 500 may include UE device 150, cellular access stations 210-1 and 210-2, RIC 410, AMF 420, and UPF 430. Communications shown in FIGS. 5A-5B provide simplified illustrations of communications in network portion 500 and are not intended to reflect every signal or communication exchanged between devices/functions.

As shown in FIG. 5A, in one implementation, cellular access station 210-1 (e.g., CU-CP 402-1) may receive signal measurement reports 505 from UE device 150 and make a decision 510 whether/when a handover to another cell (e.g., cellular access station 210-2) may be needed. Cellular access station 210-1 may send a request 515 to RIC device 410 to determine a handover type for UE device 150.

As shown at reference 518, RIC may select an appropriate type of handover for UE device 150. For example, RIC device 410 may determine whether a standard handover (e.g., for 1 Tx channel and 2 Rx channel UE devices) or an advanced handover (e.g., for advanced UE devices 150) may be used. Handover type selection 518 may include, for example, cell-specific thresholds and/or criteria to determine if a particular UE device 150 is eligible for an advanced handover. In one implementation, handover triggers, activation, and hysteresis thresholds can be optimized on a per cell basis and/or per frequency band basis using, for example, the ML component of RIC 410 described above. In another implementation, a type of handover selected for a particular UE device 150 may be based on other policies (e.g., service area restrictions, RAT frequency selection priority (RFSP) index, 5QI a service level, and/or a network slice type).

Assuming an advanced handover (e.g., using the advanced mTRP handover service described herein) is selected, RIC device 410 may provide a notice 520 to indicate to the target cellular access station 210-2 and a reply 525 to the source cellular access station 210-1. Both notice 520 and reply 525 may include the type of handover to use (i.e., advanced) and preparatory information to set up split data transmissions during the handover. The preparatory information may include handover timing/thresholds for the particular handover coverage area 220 and control plane signaling to enable cellular access stations 210-1 and 210-2 to set up a user plane data path (e.g., an Xn interface) and reserve resources to support the advanced mTRP handover service. In response to reply 525 indicating an advanced handover type decision, the source cellular access station 210-1 may send a handover required signal 530 to the appropriate AMF 420 to coordinate the advanced handover to the target cellular access station 210-2.

AMF 420 may receive signal 530 and may send a handover request 535 to cellular access station 210-2. Cellular access station 210-2 may respond to AMF 420 with a handover request acknowledgement 540, indicating cellular access station 210-2 is available to accept handover of UE device 150. AMF 420 may then provide a handover command 545 to cellular access station 210-1 for the advanced handover to the target cellular access station 210-2.

Cellular access station 210-1 may receive command 545 and provide RRC reconfiguration instructions 550 to UE device 150. RRC reconfiguration instructions 550 may include, for example, handover instructions for one transmit path (e.g., Tx #2 data path) and 2-to-1 multiplexing. Referring to FIG. 5B, additionally, AMF 420 may send an add status message 552 to cellular access station 210-2, to configure cellular access station 210-2 to receive inter-RAN communications from cellular access station 210-1. Cellular access station 210-1, in response to RRC reconfiguration instructions 550, may send an add path message 554 to establish communications between cellular access station 210-1 and cellular access station 210-2 for an Xn interface (or another path) for transfer of user plane data during a handover period.

At 560, UE 150 may use information in RRC reconfiguration instructions 550 to perform a random access channel (RACH) procedure for establishing communications with cellular access station 210-2 using Tx #2 channel (e.g., path 232). UE device 150 and cellular access station 210-2 may then establish a multiplexed DRB data stream on Tx #2, as indicated by signal 565. UE device 150 may continue to use a multiplexed DRB data stream on Tx #1, as indicated by signal 570. Thus, Tx #1 and Tx #2 may provide the same data stream on different Tx paths. Cellular access station 210-1 may forward communications over Tx #1 to/from cellular access station 210-2 (e.g., via the Xn interface). Cellular access station 210-2 may receive data over data path 2 (e.g., signal 565) and data path 1 (e.g., signal 570), demultiplex the data streams, and provide to UPF 430 a demultiplexed DRB data stream 575 encapsulated into a PDU.

After path 2 is established with cellular access station 210-2, cellular access station 210-1 may provide RRC reconfiguration instructions 580 to UE device 150. The timing/thresholds for sending instructions 580 may be communicated to cellular access station 210-1 via AMF 420 (e.g., at command 545) and/or RIC 410 (e.g., at reply 525). RRC reconfiguration instructions 580 may include, for example, handover instructions for the remaining transmit path (e.g., Tx #1 data path) and 2-to-1 multiplexing. Cellular access station 210-1 may use information in RRC reconfiguration instructions 580 to perform a RACH procedure 585 for establishing communications with cellular access station 210-2 using Tx #2 channel. Upon successful connection via Tx #2, the RRC reconfiguration may be completed 590 and user plane data for uplink/downlink may be sent between UE device 150 and UPF 430 via cellular access station 210-2 over Tx #1 and Tx #2, as shown by signals 595.

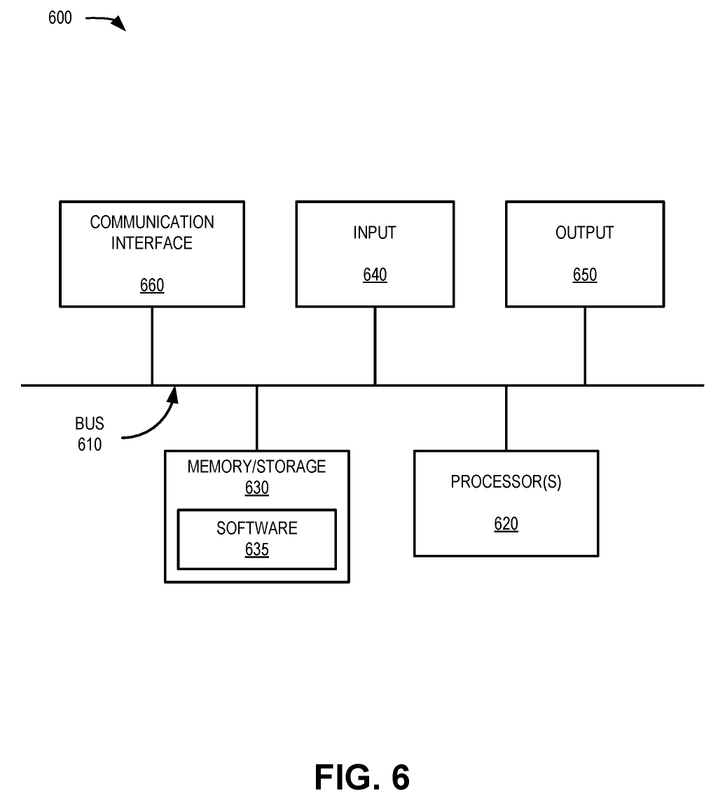

FIG. 6 illustrates example components of a device 600 according to an implementation described herein. Access device 115, core device 125, external device 135, UE device 150, cellular access station 210, RIC 410, AMF 420, UPF 430, and other devices in environment 100 may each include one or more devices 600. Device 600 may include a bus 610, a processor 620, a memory 630, an input component 640, an output component 650, and a communication interface 660.

Bus 610 may include a path that permits communication among the components of device 600. Processor 620 may include a processor, a microprocessor, ASIC, FPGA, or processing logic that may interpret and execute instructions. Memory 630 may include any type of dynamic storage device that stores information and instructions, for execution by processor 620, and/or any type of non-volatile storage device that stores information for use by processor 620. In one implementation, memory 630 may include software 635, such as software to implement the advanced mTRP handover service. Input component 640 may include a mechanism that permits a user to input information to device 600, such as a keyboard, a keypad, a button, a switch, etc. Output component 650 may include a mechanism that outputs information to the user, such as a display, a speaker, one or more light emitting diodes (LEDs), etc.

Communication interface 660 may include a transceiver that enables device 600 to communicate with other devices and/or systems via wireless communications, wired communications, or a combination of wireless and wired communications. For example, communication interface 660 may include mechanisms for communicating with another device or system via a network. Communication interface 660 may include an antenna assembly for transmission and/or reception of RF signals. For example, communication interface 660 may include one or more antennas to transmit and/or receive RF signals over the air. In one implementation, for example, communication interface 660 may communicate with a network and/or devices connected to a network. Alternatively, or additionally, communication interface 660 may be a logical component that includes input and output ports, input and output systems, and/or other input and output components that facilitate the transmission of data to other devices.

Device 600 may perform certain operations in response to processor 620 executing software instructions contained in a computer-readable medium, such as memory 630. A computer-readable medium may be defined as a non-transitory memory device. A memory device may include a single physical memory device or multiple physical memory devices. The software instructions may be read into memory 630 from another computer-readable medium or from another device. When executed by processor 620, the software instructions contained in memory 630 may cause processor 620 to perform processes described herein. Alternatively, hardwired circuitry may be used in place of or in combination with software instructions to implement processes described herein. Thus, implementations described herein are not limited to any specific combination of hardware circuitry and software.

Although FIG. 6 shows exemplary components of device 600, in other implementations, device 600 may contain fewer components, additional components, different components, or differently arranged components than those depicted in FIG. 6. Additionally, or alternatively, one or more components of device 600 may perform one or more tasks described as being performed by one or more other components of device 600.

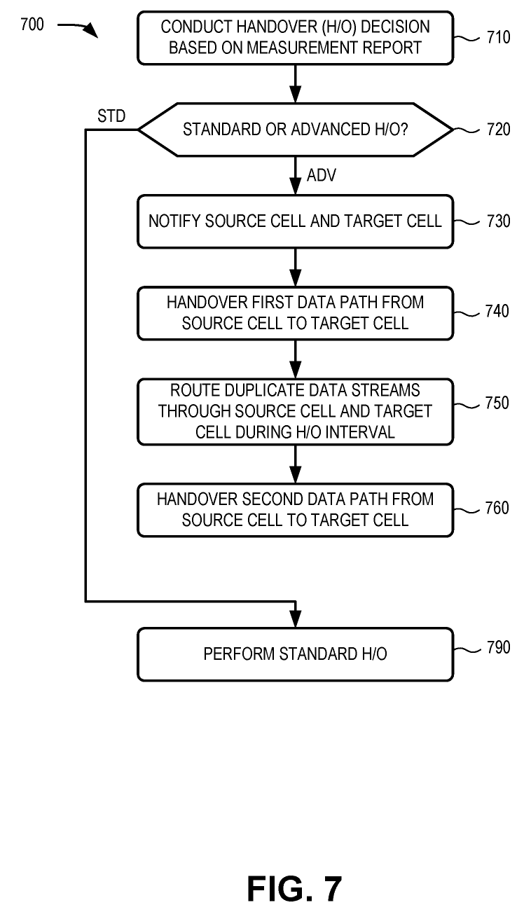

FIG. 7 is a flow diagram illustrating a process 700 for providing an advanced mTRP handover service. According to an implementation, process 700 may be performed, for example, by cellular access stations 210 in access network 110. In other implementations, process 700 may be performed by cellular access stations 210 in conjunction with RIC 410, AMF 420, UPF 430, or other devices or functions in network portion 400.

Process 700 may include initiating a handover decision based on a measurement report (block 710) and conducting a handover-type decision (block 720). For example, a cellular access station 210 (e.g., cellular access station 210-1) may receive measurement reports from UE device 150 indicating, for example, that UE device 150 is approaching a geographic edge of a cell coverage area (e.g., a cell edge) and determine that a handover to another cell (e.g., cellular access station 210-2) is necessary (e.g., as illustrated in FIGS. 2A and 3A). The cellular access station 210 may submit to RIC 410, or another RAN function, a request for a handover-type decision (e.g., request 515 of FIG. 5A). RIC 410, or another RAN function, may evaluate if UE device 150 is an advanced UE device that can support the advanced mTRP handover service. In one implementation, RIC 410 may also evaluate network congestion levels (e.g., RAN congestion, delays, etc.), capacities of cellular access stations 210, and/or performance parameters to determine if use of the advanced mTRP handover service should be used. RIC 410 may inform cellular access station 210 of a handover-type decision (i.e., standard handover or advanced handover).

If the handover-type decision indicates an advanced handover (block 720 – advanced), process 700 may further include notifying a source cell and a target cell of an advanced handover (block 730) and handing over a first data path from the source cell to the target cell (block 740). For example, RIC 410 may notify the target cell (cellular access station 210-2) and the source cell (e.g., cellular access station 210-1) of an impending handover for the advanced mTRP handover service. The notification may include preparatory information for both the source and target cellular access stations 210. The source cell (e.g., cellular access station 210-1) may signal to the AMF (e.g., AMF 420) that an advanced handover is needed and may provide handover thresholds (e.g., as indicated by RIC 410) for the particular handover coverage area. AMF 420 may confirm availability of the target cell and instruct the source cell (e.g., cellular access station 210-1) to initiate a handover of one data path (e.g., Tx #2) for UE device 150.

Process 700 may also include routing duplicate data streams through the source cell and the target cell during a handover interval (block 750) and handing over a second data path from the source cell to the target cell (block 760). For example, the source cell (e.g., cellular access station 210-1) may set up a path to forward user plane data to the target cell (e.g., cellular access station 210-2) during the handover period. Using one data path through cellular access station 210-1 and another data path through cellular access station 210-2, UE device 150 may send duplicate data streams that will both eventually reach the target cell (e.g., cellular access station 210-2). The data received by the target cell may be aggregated, de-duplicated, and/or ordered for forwarding to a UPF (e.g., UPF 430). After completion of the RACH procedure with the target cell (e.g., cellular access station 210-2) for Tx #2, the source cell (e.g., cellular access station 210-1) may initiate a handover of the remaining source data path (e.g., Tx #1) for UE device 150, and UE device 150 may perform a RACH procedure with the target cell (e.g., cellular access station 210-2) to establish the second data path with the target cell.

If the handover-type decision indicates a standard handover (block 720 – standard), process 700 may include performing a standard handover procedure (block 790). For example, if it is determined that UE device 150 does not include technology to support an advanced handover or if network resources in the RAN are overloaded, RIC 410 and/or a cellular access station 210 may designate that the UE device 150 perform a standard handover procedure between cellular access station 210-1 and cellular access station 210-2, which may include a data interruption gap.

As set forth in this description and illustrated by the drawings, reference is made to "an exemplary embodiment," "an embodiment," "embodiments," etc., which may include a particular feature, structure or characteristic in connection with an embodiment(s). However, the use of the phrase or term "an embodiment," "embodiments," etc., in various places in the specification does not necessarily refer to all embodiments described, nor does it necessarily refer to the same embodiment, nor are separate or alternative embodiments necessarily mutually exclusive of other embodiment(s). The same applies to the term "implementation," "implementations," etc.

The foregoing description of embodiments provides illustrations but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are accordingly to be regarded as illustrative rather than restrictive.

The terms "a," "an," and "the" are intended to be interpreted to include one or more items. Further, the phrase "based on" is intended to be interpreted as "based, at least in part, on," unless explicitly stated otherwise. The term "and/or" is intended to be interpreted to include any and all combinations of one or more of the associated items. The word "exemplary" is used herein to mean "serving as an example." Any embodiment or implementation described as "exemplary" is not necessarily to be construed as preferred or advantageous over other embodiments or implementations.

In addition, while series of communications have been described with regard to FIGS. 5A-5B and series of blocks have been described with regard to the processes illustrated in FIG. 7, the order of the communications and blocks may be modified according to other embodiments. Further, non-dependent blocks may be performed in parallel. Additionally, other processes described in this description may be modified and/or non-dependent operations may be performed in parallel.

Embodiments described herein may be implemented in many different forms of software executed by hardware. For example, a process or a function may be implemented as "logic," a "component," or an "element." The logic, the component, or the element, may include, for example, hardware, or a combination of hardware and software.

Embodiments have been described without reference to the specific software code because the software code can be designed to implement the embodiments based on the description herein and commercially available software design environments and/or languages. For example, various types of programming languages including, for example, a compiled language, an interpreted language, a declarative language, or a procedural language may be implemented.

Use of ordinal terms such as "first," "second," "third," etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 620) of a device. A non-transitory storage medium includes one or more of the storage mediums described in relation to memory/storage 630. The non-transitory computer-readable storage medium may be implemented in a centralized, distributed, or logical division that may include a single physical memory device or multiple physical memory devices spread across one or multiple network devices.

To the extent the aforementioned embodiments collect, store or employ personal information of individuals, it should be understood that such information shall be collected, stored, and used in accordance with all applicable laws concerning protection of personal information. Additionally, the collection, storage and use of such information can be subject to consent of the individual to such activity, for example, through well known "opt-in" or "opt-out" processes as can be appropriate for the situation and type of information. Collection, storage and use of personal information can be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such. All structural and functional equivalents to the elements of the various aspects set forth in this disclosure that are known or later come to be known are expressly incorporated herein by reference and are intended to be encompassed by the claims.

What is claimed is:

1. A method comprising:
receiving, by a network device, an indication that a handover procedure is required for a user equipment (UE) device;
selecting, by the network device, between a first handover procedure that uses one transmission and reception point (TRP) for the UE device and a second handover procedure that uses multiple TRPs for the UE device; and
notifying, by the network device, a source cell and a target cell of the second handover procedure, when the second handover procedure is selected.

2. The method of claim 1, further comprising:
selecting the second handover procedure;
providing, to the UE device, handover instructions to the target cell for a first transmit channel; and
providing, to the UE device, instructions to maintain a user plane connection with the source cell for a second transmit channel.

3. The method of claim 2, further comprising:
providing, to the UE device, handover instructions to the target cell for the second transmit channel after completion of a handover to the target cell for a first transmit channel.

4. The method of claim 2, wherein the handover instructions to the target cell for the first transmit channel include instructions for 2-to-1 multiplexing over the first transmit channel and the second transmit channel.

5. The method of claim 2, further comprising:
providing a demultiplexed data radio bearer based on data in the first transmit channel and the second transmit channel.

6. The method of claim 1, further comprising:
establishing a data path, for user plane traffic from the UE device, between the source cell and the target cell.

7. The method of claim 1, wherein the selecting is based on at least one of:
advertised capabilities of the UE device,
an indication of actual dual transmit (Tx) connections, or
a stored profile of the UE device.

8. The method of claim 7, wherein the selecting is further based on:
performance parameters for the UE device; or
network conditions at the source cell or the target cell.

9. The method of claim 1, wherein the network device includes:
a Radio Access Network (RAN) intelligent controller (RIC); or
a Centralized Unit (CU).

10. A system comprising:
a first network device including a first processor to:
receive an indication that a handover procedure is required for a user equipment (UE) device;
select between a first handover procedure that uses one transmit channel by the UE device and a second handover procedure that uses two transmit channels by the UE device; and
notify a source cell and a target cell of the second handover procedure, when selecting the second handover procedure.

11. The system of claim 10, further comprising:
a second network device including a second processor to:
provide, to the UE device, handover instructions to the target cell for a first data path, and
provide, to the UE device, instructions to maintain a connection with the source cell for a second data path.

12. The system of claim 11, wherein, when the first network device selects the second handover procedure, the second processor is further to:
provide, to the UE device, handover instructions to the target cell for the second data path after completion of a handover to the target cell for a first data path.

13. The system of claim 11, wherein the handover instructions to the target cell for the first data path include instructions for 2-to-1 multiplexing over the first data path and the second data path.

14. The system of claim 11, further comprising:
a third network device including a third processor to:
provide a demultiplexed data radio bearer based on data in the first data path and the second data path.

15. The system of claim 14, wherein the second network device and the third network device each include:
a control unit – user plane (CU-UP) for a cellular access station, or
a packet data convergence protocol (PDCP) layer of a cellular access station.

16. The system of claim 11, wherein the second processor is further to:
establish a data path, for user plane traffic from the UE device, between the source cell and the target cell.

17. A non-transitory, computer-readable storage medium storing instructions, executable by a processor of a network device, for:
receiving an indication that a handover procedure is required for a user equipment (UE) device;
selecting between a first handover procedure that uses one transmission and reception point (TRP) for the UE device and a second handover procedure that uses multiple TRPs for the UE device; and
notifying a source cell and a target cell of the second handover procedure, when the second handover procedure is selected.

18. The non-transitory, computer-readable storage medium of claim 17, wherein the selecting is based on at least one of:
advertised capabilities of the UE device,
an indication of actual dual transmit (Tx) connections, or
a stored profile of the UE device.

19. The non-transitory, computer-readable storage medium of claim 17, wherein the selecting is based on:
performance parameters for the UE device; or
network conditions at the source cell or the target cell.

20. The non-transitory, computer-readable storage medium of claim 17, wherein the selecting is based on network criteria specific to a handover coverage area between the source cell and the target cell.
